(19) United States
(12) Patent Application Publication
(10) Pub. No.: US 2024/0220783 A1
(43) Pub. Date: Jul. 4, 2024

(54) MIXED PRECISION QUANTIZATION OF AN ARTIFICIAL INTELLIGENCE MODEL

(71) Applicant: Samsung Electronics Co., Ltd., Suwon-si (KR)

(72) Inventors: Arun CHAUHAN, Bangalore (IN); Utsav TIWARI, Bangalore (IN); Vikram Nelvoy RAJENDIRAN, Bangalore (IN); Payal ANAND, Bangalore (IN); Hitesh KUMAR, Bangalore (IN); Rohit SAXENA, Bengaluru (IN)

(21) Appl. No.: 18/431,455

(22) Filed: Feb. 2, 2024

Related U.S. Application Data
(63) Continuation of application No. PCT/IB2023/063360, filed on Dec. 29, 2023.

(30) Foreign Application Priority Data
Jan. 3, 2023 (IN) 202341000351
Nov. 2, 2023 (IN) 2023 41000351

(51) Int. Cl. G06N 3/0495

(52) U.S. Cl. CPC G06N 3/0495

(57) ABSTRACT

A method for mixed precision quantization of an artificial intelligence (AI) model by an electronic device is included. The method includes performing, by the electronic device, perturbation in weights of each layer of a plurality of layers of the AI model for a pre-defined number of times, determining, by the electronic device, a change in an output of each layer of a plurality of layers of the AI model based on a perturbation in weights of each layer of the plurality of layers, determining, by the electronic device, a sensitivity metric for each layer of the plurality of layers of the AI model as a measure of the change in the output of each layer, assigning, by the electronic device, a bit-precision to each layer of the plurality of layers of the AI model based on the determined sensitivity metric, and performing, by the electronic device, the mixed precision quantization of the AI model using the bit-precision assigned to each layer of the plurality of layers of the AI model.

### CROSS-REFERENCE TO RELATED APPLICATION(S)

This application is a continuation application, claiming priority under § 365(c), of an International application No. PCT/IB2023/063360, filed on Dec. 29, 2023, which is based on and claims the benefit of an Indian Provisional patent application number 202341000351, filed on Jan. 3, 2023, in the Indian Intellectual Property Office, and of an Indian Complete patent application number 202341000351, filed on Nov. 2, 2023, in the Indian Intellectual Property Office, the disclosure of each of which is incorporated by reference herein in its entirety.

### BACKGROUND

### 1. Field

The disclosure relates to artificial intelligence (AI) model compression for an electronic device. More particularly, the disclosure relates to a mixed precision quantization of the AI model.

### 2. Description of Related Art

The scale of neural networks and their speed/power of inference have presented significant challenges for deployment in electronic devices. A promising solution to address these issues is quantization. However, uniform quantization of a model to ultra-low precision can result in a considerable loss of accuracy. The parameters of neural networks, which are often over-parameterized and represented by high bit precision such as 32-bit floating point numbers, offer ample opportunity to decrease bit precision to values such as 16-bit, 8-bit, or 4-bit. Reduced bit precision of the parameters may lead to improved memory usage, higher performance, and lower energy consumption. Quantization can either be applied uniformly across all layers of the neural network, which may not always lead to an optimal solution, or unique bit precisions may be applied to individual layers of the network for a more ideal result.

Existing techniques for achieving mixed precision quantization have attempted to use search-based or criterion-based methods. Search-based approaches, such as those utilizing reinforcement learning, can be time-consuming, while criterion-based methods rely on second-order approximations, such as approximating hessian trace.

Mixed precision techniques can potentially reduce the runtime and memory needs of neural networks by appropriately assigning a suitable data type to each operation. This may be achieved through either reinforcement learning or regression analysis. Reinforcement learning, a discipline that studies the art of decision-making, is often employed in this process. A unique aspect of mixed precision quantization service is its ability to iteratively increase object size. The service may initially assume that all objects, including weights, should be transformed to a smaller data type like an 8-bit integer.

The mixed precision quantization service is capable of selecting objects in an iterative manner to augment from a smaller data type to a larger one (for instance, from 8-bit integers to 12-bit integers) while ensuring that the target object bandwidth is not exceeded. This service makes use of a meticulously sorted collection of objects produced at block to determine which objects should undergo size enhancement. The mixed precision quantization service may commence with objects that consume less bandwidth and gradually advance to increase the size of objects consuming higher bandwidth.

Neural networks, such as Artificial Neural Networks (ANNs), commonly employ various normal-precision floating-point formats, including 16-bit, 32-bit, 64-bit, and 80-bit floating point formats, for their internal computations. The process of training ANNs may be highly demanding in terms of both computation and storage, requiring billions of operations and gigabytes of storage. There are ways to optimize neural network performance, energy consumption, and storage requirements, such as the adoption of quantized-precision floating-point formats during training and/or inference. These formats may entail reduced bit width, involving the use of fewer bits to represent a number's mantissa and/or exponent, or block floating-point (BFP) formats, which employ a limited mantissa of 3, 4, or 5 bits, along with an exponent shared by two or more numbers.

The application of quantized-precision formats may detrimentally affect neural networks, causing a reduction in accuracy, among other potential detriments. The approach requires the utilization of second order techniques, such as the hessian trace, which is defined as the divergence of a gradient field in Riemannian geometry. The network can learn the most effective behavior to exhibit in a particular environment to maximize reward. However, it is worth noting that mixed precision quantization does not rely on first order techniques.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a mixed precision quantization of an artificial intelligence model.

Another aspect of the disclosure is to determine a mixed-precision quantized AI model based on an assigned bit-precision to each layer of a plurality of layers.

Another aspect of the disclosure is to achieve an optimal performance for every layer within the multiple layers of the AI model, concerning power consumption, memory allocation, computational efficiency, and on-device learning, all on an electronic device.

Another aspect of the disclosure is to provide most optimized configuration for quantization.

Another aspect of the disclosure is to reduce computational requirements, and leading to lower power consumption.

Another aspect of the disclosure is to facilitate direct training quantization and deployment on the electronic device, thereby minimizing memory usage and optimizing computational and power efficiency.

another aspect of the disclosure is to perturb weights of each layer of the plurality of layers of the AI model for a pre-defined number of times and estimate a change in output of each layer by calculating an average gradient value as a result of the perturbation.

Another aspect of the disclosure is to determine the sensitivity of every layer within the AI model, which acts as a measure of the anticipated alteration in the output observed at each layer.

Another aspect of the disclosure is to allocate a specific bit precision to individual layers based on their determined sensitivity and subsequently employ this bit precision assignment for quantizing the AI model.

Additional aspects will be set forth in part in the description which follows and, in part, will be apparent from the description, or may be learned by practice of the presented embodiments.

In accordance with an aspect of the disclosure, a method for mixed precision quantization of an artificial intelligence (AI) model by an electronic device is provided. The method includes performing, by the electronic device, perturbation in weights of each layer of a plurality of layers of the AI model for a pre-defined number of times, determining, by the electronic device, a change in an output of each layer of the plurality of layers of the AI model based on the perturbation in the weights of each layer of the plurality of layers, determining, by the electronic device, a sensitivity metric for each layer of the plurality of layers of the AI model as a measure of the change in the output of each layer, assigning, by the electronic device, a bit-precision to each layer of the plurality of layers of the AI model based on the determined sensitivity metric, and performing, by the electronic device, the mixed precision quantization of the AI model using the bit-precision assigned to each layer of the plurality of layers of the AI model.

In another aspect, the change in the output is determined by determining a gradient of loss of each layer of the plurality of layers based on the perturbing weights of each layer of the plurality of layers, and determining the change in the output of each layer of the plurality of layers of the AI model based on the gradients of loss of each layer of the plurality of layers. The change in the output indicates loss with respect to each layer of the plurality of layers.

In another aspect, the sensitivity metric for each layer of the plurality of layers of the AI model is determined based on the gradients of loss.

In another aspect, assigning, by the electronic device, the bit-precision to each layer of the plurality of layers of the AI model based on the sensitivity metric includes constructing, by the electronic device, a constrained optimization problem model using the sensitivity metric for each layer of the plurality of layers and a net compression ratio, and assigning, by the electronic device, the bit precision to each layer of the plurality of layers based on the constrained optimization problem model.

In another aspect, performing, by the electronic device, the mixed precision quantization of the AI model using the bit-precision assigned to each layer of the plurality of layers of the AI model includes enabling, by the electronic device, each layer of the plurality of layers to be on the assigned bit-precision to obtain an optimal mixed-precision quantized AI model by performing a post training quantization of the AI model using the assigned bit-precision to each of the plurality of layers.

In another aspect, the optimal AI model obtains an optimal performance of each layer of the plurality of layers of the AI model in terms of a power level, an amount of memory usage, a level of computational efficiency, and/or OnDevice Learning on the electronic device.

In another aspect, the bit-precision is assigned to each layer of the plurality of layers of the AI model by selecting at least one bit from a bit-precision set based on the sensitivity metric.

In accordance with another aspect of the disclosure, an electronic device for mixed precision quantization of an artificial intelligence (AI) model is provided. The electronic device includes memory, one or more processors, and a mixed precision quantization controller communicatively coupled to the memory, and the one or more processors, wherein the memory store one or more computer programs including computer-executable instructions that, when executed by the one or more processors, cause the electronic device to perform perturbation in weights of each layer of a plurality of layers of the AI model for a pre-defined number of times, determine a change in an output of each layer of the plurality of layers of the AI model based on the perturbation in the weights of each layer of the plurality of layers, determine a sensitivity metric for each layer of the plurality of layers of the AI model as a measure of the change in the output of each layer, and assign an bit-precision to each layer of the plurality of layers of the AI model based on the determined sensitivity metric, and perform quantization of the AI model using the bit-precision assigned to each layer of the plurality of layers of the AI model.

In accordance with another aspect of the disclosure, one or more non-transitory computer-readable storage media storing one or more computer programs including computer-executable instructions that, when executed by one or more processors of an electronic device for a mixed precision quantization of an artificial intelligence (AI) model, cause the electronic device to perform operations are provided. The operations include performing, by the electronic device, perturbation in weights of each layer of a plurality of layers of the AI model for a pre-defined number of times, determining, by the electronic device, a change in an output of each layer of the plurality of layers of the AI model based on the perturbation in the weights of each layer of the plurality of layers, determining, by the electronic device, a sensitivity metric for each layer of the plurality of layers of the AI model as a measure of the change in the output of each layer, assigning, by the electronic device, a bit-precision to each layer of the plurality of layers of the AI model based on the determined sensitivity metric, and performing, by the electronic device, the mixed precision quantization of the AI model using the bit-precision assigned to each layer of the plurality of layers of the AI model.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a block diagram of an electronic device for performing a mixed precision quantization of an AI model, according to an embodiment of the disclosure;

FIG. 2 is a block diagram illustrating a mixed precision quantization controller integrated within an electronic device, demonstrating an advanced mixed precision quantization technique applied to an AI model according to an embodiment of the disclosure;

FIG. 3 is an schematic diagram elucidating a mixed precision quantization of an AI model, according to an embodiment of the disclosure;

FIG. 4 illustrates a graphical depicting of a loss curve Loss function, showcasing a point of convergence within a loss function, according to an embodiment of the disclosure;

FIG. 5A illustrates a graphical representation of a loss curve in relation to weights pertaining to a particular layer, namely Layer-1, according to an embodiment of the disclosure;

FIG. 5B illustrates a graphical representation of a loss curve as it pertains to weights of Layer-2, according to an embodiment of the disclosure;

FIG. 5C illustrates a graphical representation of computation of a mean gradient norm through a perturbation of weights in N-random orientations, according to an embodiment of the disclosure;

FIG. 6 illustrates a graphical representation of an estimation of loss variation across diverse bit-precision levels applicable to a given layer, according to an embodiment of the disclosure;

FIG. 7 is a flow chart illustrating a method for mixed precision quantization of an AI model based on an average gradient norm, according to an embodiment of the disclosure; and

FIG. 8 is a flow chart illustrating a method for mixed precision quantization of an AI model, according to an embodiment of the disclosure.

Throughout the drawings, like reference numerals will be understood to refer like parts, components, and structures.

Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the disclosure. Furthermore, the one or more elements may have been represented in the drawing by conventional symbols, and the drawings may show only those specific details that are pertinent to the understanding the embodiments of the disclosure so as not to obscure the drawing with details that will be readily apparent to those of ordinary skill in the art having benefit of the description herein.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The various embodiments described herein are not necessarily mutually exclusive, as some embodiments may be combined with one or more other embodiments to form new embodiments. The term “or” as used herein, refers to a non-exclusive or, unless otherwise indicated. The examples used herein are intended merely to facilitate an understanding of ways in which the embodiments herein may be practiced and to further enable those skilled in the art to practice the embodiments herein. The examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. The blocks of the embodiments may be physically combined into more complex blocks without departing from the scope of the disclosure.

The accompanying drawings are used to help easily understand various technical features and it should be understood that the embodiments presented herein are not limited by the accompanying drawings. The disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

The embodiments disclose a method for mixed precision quantization of an AI model. The method includes performing perturbation in weights of each layer of a plurality of layers of the AI model for a pre-defined number of times. The method includes determining a change in an output of each layer of the plurality of layers of the AI model based on the perturbation in the weights of each layer of the plurality of layers. The method, for example, includes determine a sensitivity metric for each layer of the plurality of layers of the AI model as a measure of the change in the output of each layer, and assigning an bit-precision to each layer of the plurality of layers of the AI model based on the determined sensitivity metric. The method, for example, includes determining a mixed-precision quantized AI model based on the assigned bit-precision to each layer of the plurality of layers.

Based on the proposed method, the quantization of the model entails the allocation of varying bit widths to diverse layers through a computationally efficient first-order technique, such as linear computational complexity. This approach ensures optimal performance in terms of power, memory, and latency, while preserving accuracy. The first-order method employs gradient information alone to determine the mixed-precision settings of the neural network, enabling the generation of quantized networks within 1.5% of the original model accuracy in much faster computation time. The proposed approach does not assume that a convergence point of the pre-trained neural network represents a local minimum. It is more versatile than prior art methods as it considers convergence points as both convergence points and local minima.

Quantization is a widely adopted technique in deep learning that effectively minimizes neural network memory requirements and computational complexity, while simultaneously preserving acceptable accuracy levels. This method entails utilizing lower precision numerical representations to encode parameters and activations of deep neural networks (DNNs), thereby achieving significant reductions in memory bandwidth and usage. Quantization has the potential to significantly enhance the performance of electronic devices such as mobile phones, servers, and smartwatches, as well as more resource-constrained devices like IoT devices and autonomous driving vehicles.

Mixed Precision Quantization (MPQ) is a novel quantization technique that allows for the use of varying bit widths for different layers within a DNN model. This is a departure from the traditional quantization approach where all layers are restricted to the same bit width. The MPQ technique facilitates, for example, optimal performance in terms of power consumption, memory usage, and latency, without compromising the accuracy of the model. Each layer may be configured to operate at a suitable bit-precision selected from a set of options, such as 2-bit, 4-bit, 8-bit, 16-bit, and so forth. This flexibility enables the creation of a highly optimized model with each layer functioning at the most appropriate bit-precision level.

The MPQ exploits the trade-off between precision and computational efficiency while deploying DNN models. Given that DNNs entail millions and billions of parameters, the need for substantial memory storage is indispensable. Utilization of the MPQ can potentially offer the most optimal configuration for quantization. By quantizing parameters and activations to lower formats, memory resources are saved significantly, which is particularly useful for devices that are resource-constrained.

The proposed method and electronic device suggests that lower precision formats may necessitate fewer resources for storage and computations. The DNN model could conduct faster operations, ultimately enhancing inference. This aspect holds paramount significance in real-time applications that demand low latency.

DNN models often demand significant computational power, leading to elevated power consumption. The utilization of the MPQ approach, as put forth in the proposed method, effectively mitigates the computational demands, thereby reducing power consumption. This aspect is particularly critical for electronic devices to accommodate AI models while seamlessly executing DNN models in the background.

Electronic devices are inclined towards memory constraints and have comparatively limited computational resources in comparison to cloud-based servers. The proposed method entails the employment of the MPQ, which facilitates training, quantization, and deployment directly on electronic devices owing to its compact memory footprint and improved computational and power efficiency. The MPQ enables an On-Device learning approach and may be utilized for model deployment on specialized hardware. As per the proposed method, various hardware supports offer different precision levels on electronic devices.

The proposed disclosure demonstrates versatility across various multi-model applications, including but not limited to selfie enhancement, bokeh implementation, gaming applications, expert-level raw denoising, and image restoration.

It should be appreciated that the blocks in each flowchart and combinations of the flowcharts may be performed by one or more computer programs which include instructions. The entirety of the one or more computer programs may be stored in a single memory or the one or more computer programs may be divided with different portions stored in different multiple memories.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

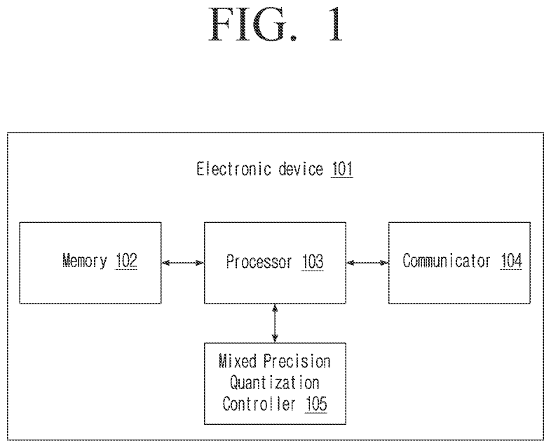

FIG. 1 illustrates a block diagram of an electronic device (101) for performing a mixed precision quantization of an AI model, according to an embodiment of the disclosure. The electronic device (101) includes a memory (102), a processor (103), a communicator (104), and a mixed precision quantization controller (105).

A memory (102) stores instructions to be executed by a processor (103). The memory (102) includes non-volatile storage elements. Examples of such nonvolatile storage elements include magnetic hard discs, optical discs, floppy discs, flash memories, or forms of Electrically Programmable Memories (EPROM) or Electrically Erasable and Programmable Memories (EEPROM). Additionally, the memory (102) in some examples, be considered a non-transitory storage medium. The term “non-transitory” indicates that the storage medium is not embodied in a carrier wave or a propagated signal. The term “non-transitory” is not be interpreted that the memory (102) is nonmovable. The memory (102) stores larger amounts of information. In certain examples, a non-transitory storage medium stores data that can, over time, change (e.g., in Random Access Memory (RAM) or cache). The processor (103) includes one or a plurality of processors.

The one or more processors (103) is a general-purpose processor, such as a central processing unit (CPU), an application processor (AP), or the like, a graphics processing unit such as a graphics processing unit (GPU), a Visual Processing Unit (VPU), and/or an AI dedicated processor such as a neural processing unit (NPU). In an embodiment, the processor (103) includes multiple cores and executes the instructions stored in the memory (102).

The one or more processors control the processing of the input data in accordance with a predefined operating rule or AI model stored in the non-volatile memory and the volatile memory. The predefined operating rule or artificial intelligence model is provided through training or learning.

Being provided through learning means that, by applying a learning approach to a plurality of learning data, a predefined operating rule or AI model of a desired characteristic is made. The learning may be performed in a device itself in which AI according to an embodiment is performed, and/o may be implemented through a separate server/system.

In another embodiment, the AI model may consist of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning approach is a method for training a predetermined target device (for example, an edge device) using a plurality of learning data to cause, allow, or control the target device to make a determination or prediction. Examples of learning method include, but are not limited to, supervised learning, unsupervised learning, semi-supervised learning, or reinforcement learning.

In an embodiment, the communicator (104) includes an electronic circuit specific to a standard that enables wired or wireless communication. The communicator (104) communicates internally between internal hardware components of the electronic device (101) and with external devices via one or more networks.

In another embodiment, the mixed precision quantization controller (105) is a sophisticated hardware entity vested with the responsibility of directing and managing the flow of data between two distinct entities. In the realm of computing, this device may take on the form of microchips, cards, or other separate hardware mechanisms, each designed to oversee a gamut of electronic device (101) operations. The mixed precision quantization controller (105) serves as an intermediary linking two electronic devices, actively managing and directing communication between said devices.

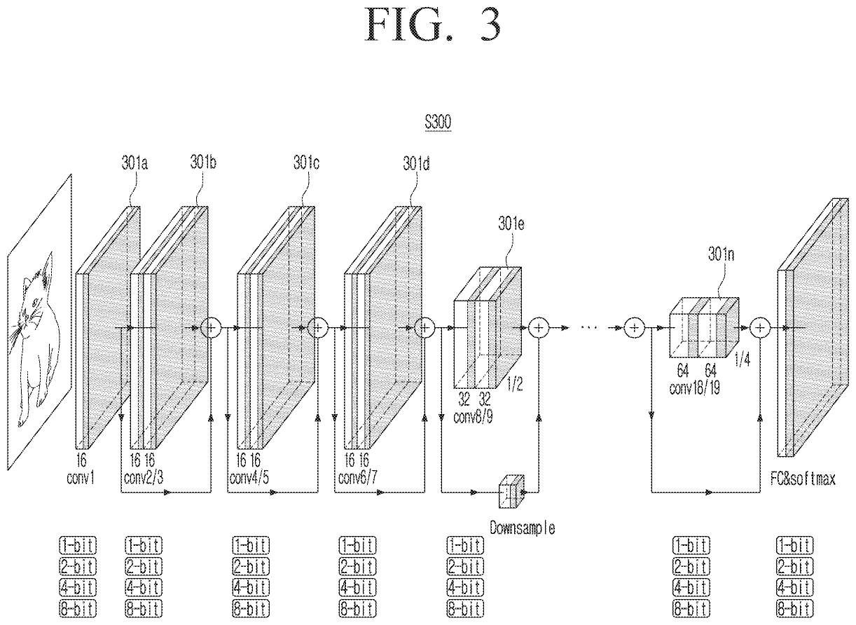

The mixed precision quantization controller (105) performs perturbation in weights of each layer of multiple layers (301ₐ₋ₙ) (or layers (301ₐ₋ₙ)) (i.e., 301a, 301b, 301c, 301d, 301e . . . 301n of FIG. 3) of the AI model for a pre-defined number of cycles. Such cycles are established either by the electronic device (101) or by its user.

Based on the perturbation in the weights of each layer of the multiple layers (301ₐ₋ₙ), the mixed precision quantization controller (105) determines a change in an output of each layer of the multiple layers (301ₐ₋ₙ) of the AI model. In an embodiment, the mixed precision quantization controller (105) determines a gradients of loss of each layer of the multiple layers (301ₐ₋ₙ) based on the perturbing weights of each layer of the multiple layers. Further, the mixed precision quantization controller (105) determines the change in the output of each layer of the multiple layers (301ₐ₋ₙ) of the AI model based on the gradients of loss of each layer of the multiple layers (301ₐ₋ₙ). The change in the output indicates loss with respect to each layer of the multiple layers.

The mixed precision quantization controller (105) determines a sensitivity metric for each layer of the multiple layers (301ₐ₋ₙ) of the AI model as a measure of the change in the output of each layer. The sensitivity metric for each layer of the multiple layers (301ₐ₋ₙ) of the AI model is determined based on the gradients of loss.

By utilizing the determined sensitivity metric, the mixed precision quantization controller (105) skillfully designates a precise bit-precision to each layer within the multitude of layers (301ₐ₋ₙ) comprising the AI model. In an embodiment, the mixed precision quantization controller (105) formulates a restricted optimization problem model utilizing the sensitivity metric for each layer in conjunction with a net compression ratio. Following this, the mixed precision quantization controller (105) employs the optimization model to assign the appropriate bit-precision to each layer within the multitude of layers (301ₐ₋ₙ). The sensitivity metric is crucial to this process as it allows for the selection of at least one bit from a set of possible bit-precisions to be assigned to each layer.

The mixed precision quantization controller (105) employs the assigned bit-precision designated to each layer among the multiple layers constituting the AI model to perform quantization of the AI model. The mixed precision quantization controller (105) facilitates every layer of the multiple layers (301ₐ₋ₙ) to function at their designated bit-precision, ultimately resulting in an optimal mixed-precision quantized AI model. The post training quantization of the AI model is executed by the mixed precision quantization controller (105) using the assigned bit-precision specified for each of the multiple layers (301ₐ₋ₙ). The optimal AI model thereby generated achieves peak performance levels for every layer of the multiple layers (301ₐ₋ₙ) in respect of one or more aspects such as power usage, memory consumption, computational efficiency, and on-device learning capabilities on the electronic device (101).

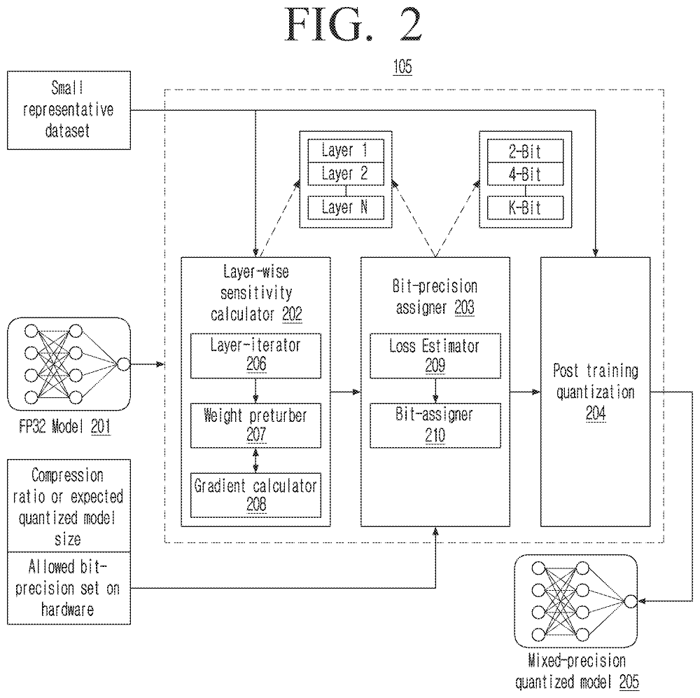

FIG. 2 is a block diagram illustrating a mixed precision quantization controller (105) integrated within an electronic device (101), demonstrating an advanced mixed precision quantization technique applied to an AI model, according to an embodiment of the disclosure. The mixed precision quantization controller (105) includes an AI model (201) (e.g., FP32 model), a layer-wise sensitivity calculator (202), a bit-precision assigner (203), a post-training quantization model (204), and a mixed precision quantization model (205). The layer-wise sensitivity calculator (202) includes a layer-iterator (206), a weight perturber (207), and a gradient calculator (208). The bit-precision assigner (203) includes a loss estimator (209) and a bit-assigner (210). The loss-estimator (209) estimates the possible losses for assignment of different bit precisions to each layer (locally). In an example, for layer-2, layer-L4, and layer-L8 represents possible losses if the loss-estimator (209) assigns 2 bit, 4 bit, or 8 bit to the AI model (201). The bit-assigner (210) is a constraint based optimizer. The bit-assigner (210) decides the final bit configuration for each layer considering total-loss from the loss-estimator (209) and the model six constraints.

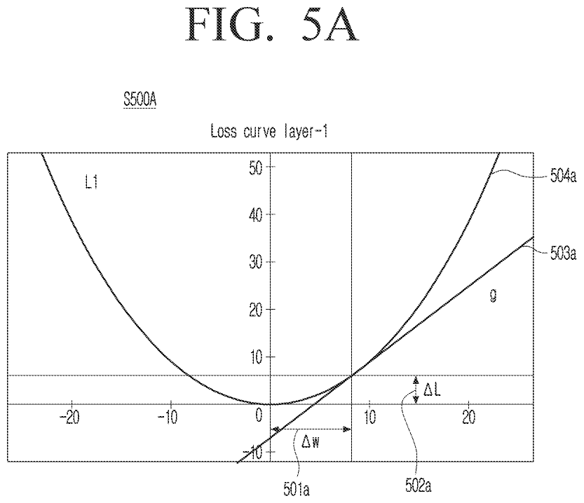

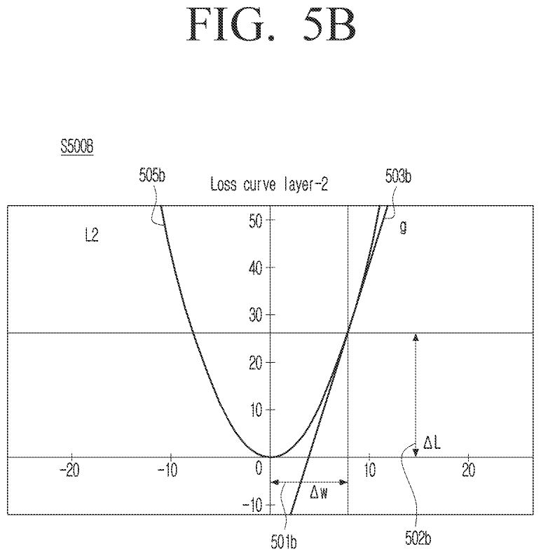

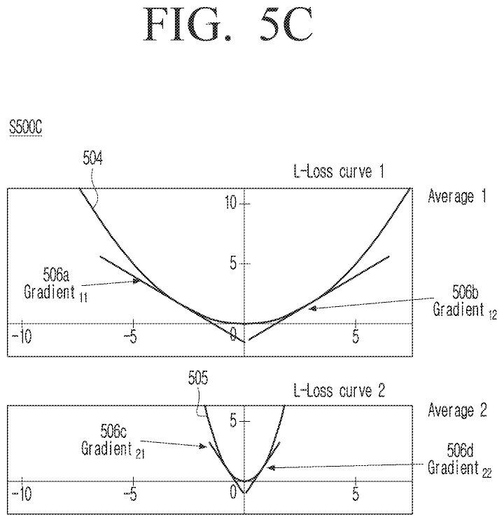

The AI model provide an input to the layer-wise sensitivity calculator (202). The layer-wise sensitivity calculator (202) determines the sensitivity of each layer of the AI model one by one. The sensitivity refers to a gradient norm. In an embodiment, the sensitivity of each layer is explained in the FIGS. 5A and 5B. The layer-iterator (206) iterates through all the layers of the AI model one by one for calculating the sensitivity. The weight perturber (207) modifies the weights of the selected layer by adding some random noise in the weight tensor. On the AI model with perturbed weights, the gradient calculator (208) performs forward propagation followed by back propagation and calculates the norm-of the gradients for the selected layer by layer-iterator. The average gradient norm (sensitivity) is calculated as follows:

$$Average Gradient Norm ( sensitivity ) G = \frac{{Σ}_{i}^{N} {‖ Gradient i ‖}_{1}}{N}$$

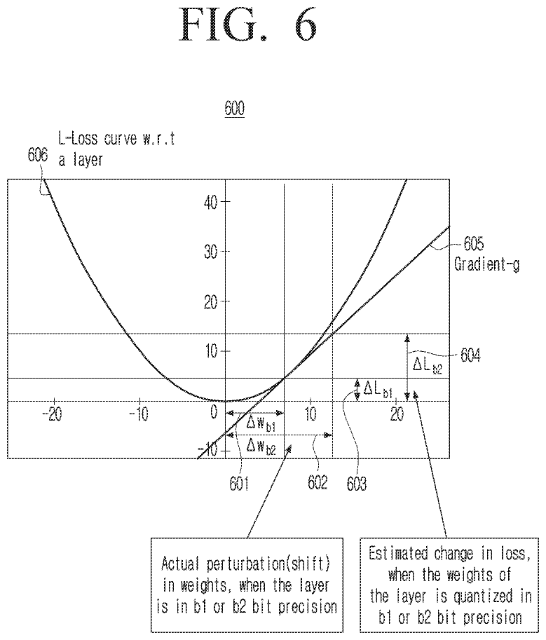

The sensitivity of each layer of the AI model of fed to the bit-precision assigner (203). The bit-precision assigner (203) computes, for example, the average-gradient-norm (i.e., sensitivity), that represents a generic rate of change in loss due to small perturbation. The operations of the bit-precision assigner (203) are explained in the FIG. 6. The computed average-gradient-norm is provided to the post-training quantization model (204).

The model post-training quantization (204) incorporates the layer-wise bit assignments to perform the quantization of the AI model, based on the provided bit-configuration. As the outcome, the system generates the mixed precision quantized model (205), which represents a neural network model quantized at distinct bit widths for different layers.

FIG. 3 is an example schematic diagram (S300) elucidating a mixed precision quantization of an AI model, according to an embodiment of the disclosure. The electronic device (101) perturbs the weights of each layer (301ₐ₋ₙ) of the AI model for the pre-defined number of times. Further, the electronic device (101) estimates the change in output of each layer as the result of the perturbation. The change in output of each layer is estimated, for example, by calculating an average gradient value after perturbing weights of the layer for the pre-defined number of times. The change in output of each layer (301ₐ₋ₙ) is directly proportional to the average gradient value and indicates a slope in loss curve with respect to each layer. The slope of the loss curve provides sensitivity of the layer. As a measure of the estimated change in the output of each layer, the electronic device (101) determines sensitivity of each layer (301ₐ₋ₙ) of the AI model. In response to the determined sensitivity, the electronic device (101) assigns the bit precision to each layer and performs the quantization the AI model using the assigned bit precision. The bit precision assignment is directly proportional to the sensitivity of the layer.

The mixed precision quantization of the AI model is performed by using a downSample, a Fully connected (FC) layer, a Softmax and a Convolution layer (conv). The DownSample downscales the resolution of image. In one example, 128×128 downscales the resolution of image to 64×64. The Fully connected (FC) layer and the convolution layer are used in the Neural Network. In the Softmax, a type of layer in the neural network normalizes the values of some intermediate output. The downSample, the FC layer, the Softmax and the conv are known in the person skilled in the art. For the sake of brevity, we are not explaining the same in the patent disclosure.

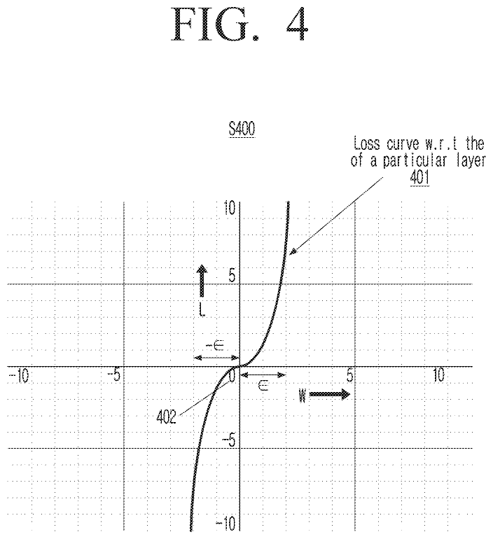

FIG. 4 illustrates a graphical (S400) depicting of a loss curve loss function, showcasing a point of convergence within a loss function, according to an embodiment of the disclosure. The convergence point is also known a saddle point.

FIG. 4 displays a loss curve (401) in conjunction with a convergence point (402). The loss curve (401) indicates that the loss function has a more marked decline in the vicinity of the convergence point (402), thereby indicating heightened sensitivity. Additionally, FIG. 4 exhibits the portrayal of the loss curve (401) in relation to the weights of a specific layer.

With reference to FIG. 4, the proposed disclosure uniquely enables a more precise measurement of the sensitivity of the multiple layers (301ₐ₋ₙ) at the convergence point (402), surpassing the limitations of conventional state-of-the-art techniques that rely solely on linear computation.

$$Loss Function : L = f ( w ) = {w}^{3} \qquad Equation 1$$

$$Gradient of Loss function : \frac{d f ( w )}{d w} = 3 w 2 \qquad Equation 2$$

Hessian (2^{nd}-order derivative) of Loss Function:

$$\frac{d 2 f ( w )}{d w 2} = 6 w \qquad Equation 3$$

As per state of the art, the sensitivity of this loss function in e proximity is calculated using average hessian trace as follows:

$$\frac{( - 6 ϵ ) + ( 6 ϵ )}{2} = 0 \qquad Equation 4$$

Sensitivity using the proposed method:

$$\frac{( 3 {ϵ}^{2} ) + ( 3 {ϵ}^{2} )}{2} = 3 {ϵ}^{2} \qquad Equation 5$$

The sensitivity metric proposed in equations 4 and 5 captures the actual sensitivity, while the current state-of-the-art metric exhibits a false, zero sensitivity, which is inaccurate.

Conventional Hessian based techniques typically compute a zero sensitivity convergence point for a given loss curve scenario, which is an erroneous outcome. The proposed method yields a noteworthy sensitivity that surpasses that of Hessian based methods.

FIG. 5A illustrates a graphical representation (S500A) of a loss curve in relation to weights pertaining to a particular layer, namely Layer-1, according to an embodiment of the disclosure. The proposed disclosure captures the curvature of the loss function, as influenced by the weights of Layer-1. It features several key components, including small-weight-perturbation (Aw) (501a), change in loss caused by perturbation (ΔL) (502a), gradient value (g) (503a), and a captivating loss curve of Layer-1 (504a).

A graphical representation (S500B) in FIG. 5B serves to depict a loss curve in relation to weights of Layer-2, as disclosed in the embodiments. The curvature of the loss function in Layer-2 is demonstrated, alongside other key elements such as the small-weight-perturbation (Aw) (501b), the alteration in loss due to the perturbation (ΔL) (502b), the gradient value (g) (503b), and the loss curve of Layer-2 itself (505b). It is observed that the gradient value (g) in the loss curve of Layer-2 is steeper than that of Layer-1 (504a), denoting greater sensitivity to weight perturbations. In simpler terms, for the same level of weight perturbation, the increase in loss is more pronounced in Layer-2 as compared to Layer-1. In an example, for the same amount of perturbation in weights the increase in loss for layer L2>L1. Thus, the Layer-2 (505b) is more sensitive than the Layer-1 (504a).

FIG. 5C presents an elegant illustration (S500C) showcasing a computation of an average gradient norm. This is achieved by perturbing the weights in N-random directions, as detailed in the disclosed embodiments. The graphical view includes four gradients (506a, 506b, 506c, 506d), along with the loss curve of Layer-1 (504) and the loss curve of Layer-2 (505). Each gradient (506a, 506b, 506c, 506d) serves a distinct purpose, with Gradient11, Gradient12, Gradient21, and Gradient22 being represented by 506a, 506b, 506c, and 506d, respectively.

The average gradient norm by perturbing the weights in N-random (here, two-directions to visualize) directions is calculated as follows:

$$Average 1 = \frac{{‖ Gradient 11 ‖}_{1} + {‖ Gradient 12 ‖}_{1}}{2} \qquad Equation 6$$

$$Average 2 = \frac{{‖ Gradient 21 ‖}_{1} + {‖ Gradient 22 ‖}_{1}}{2} \qquad Equation 7$$

$$Average 2 ≻ Average 1$$

The average gradient norm for the loss curve of layer L2 (505) is more than the layer L1 (504), thus the Layer L2 (505) is more sensitive than layer L1 (504).

FIG. 6 illustrates a graphical representation (600) of an estimation of loss variation across diverse bit-precision levels applicable to a given layer, according to an embodiment of the disclosure. The visual includes a small perturbation of the Layer in b1 bit precision (Δwb1) (601), a small perturbation of the Layer in b2 bit precision (Δwb2) (602), the change in loss due to the weights of the Layer in b1 bit precision (ΔL b1) (603), the change in loss due to the weights of the Layer in b2 bit precision (ΔL b2) (604), the gradient value (g) (605), and a loss curve (606). Through the Layer-wise sensitivity calculator or controller, the Average-gradient-norm (sensitivity) G is computed, indicating a generic rate of change in loss due to small perturbation.

$$G = \frac{Δ L}{Δ w} \qquad Equation 8$$

during calculation of Average Gradient Norm G, perturbing the weights by random amount i.e. Aw is random.

$$G = \frac{Δ L}{Δ w} ,$$

this implies ΔL=G*Δw.

For estimation of actual ΔL due to actual weight-quantization-perturbation in different bit-precision scenarios as follows:

ΔL_{b}=G*Δw_{b}, where b represents a bit-precision from the set of supported bit-precisions set on hardware like—B={2,4,8,16,32}, same may be referred from FIG. 6.

For a particular layer-i, the user of the electronic device (101) may have five (from set B) estimated loss terms for each bit-precision allowed as:
ΔZⁱ₂, ΔLⁱ₄, ΔLⁱ₈, ΔLⁱ₁₆, ΔLⁱ₃₂, similarly for all the layers iϵ{1 . . . L}.

For each layer only one of the bit precision may be selected out of the allowed set B. Further, picking one b out of set B results in:
Change in the loss=ΔLⁱ_{b}
Change in the size=b*Pᵢ, where Pᵢ represents number of parameters in the layer-i.

The aim of the objective function is to minimize the overall loss represented by ΔL (which is the sum of all ΔLib, where b-bit-precision is selected for layer-i). On the other hand, the constraint requires that the total size of the model represented by S (which is the summation of b*Pi, where b-bit-precision is chosen for layer-i) remains within a specified limit.

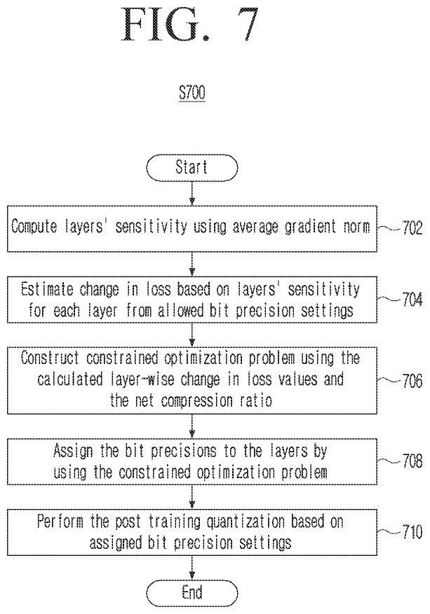

FIG. 7 is a flow chart (S700) illustrating a method for mixed precision quantization of an AI model based on an average gradient norm, according to an embodiment of the disclosure. The operations (S702-S710) are handled by the mixed precision quantization controller (105).

At operation 702 of the method, layers' sensitivity is computed by leveraging the average gradient norm (or average gradient value). Moving forward to operation 704, the method involves estimating the change in loss for each layer by considering their sensitivity in relation to the allowed bit precision settings. Subsequently, at operation 706, the method constructs a constrained optimization problem model using the calculated change in loss values for each layer and the net compression ratio. The constrained optimization problem model tries to optimize a given objective function and provides decision variables as the result, and keeps some constraints in consideration. The constrained optimization problem model has considered the target model size as constraint and the total loss due to model quantization as an objective function to minimize. The method have kept bit precision for each layer as decision variable, after solving the optimization problem model. The constrained optimization problem model finally provides the decision variables as output which represents bit precision to be assigned to each layer. Operation 708 involves the assignment of bit precisions to the layers utilizing the optimized solution from the constrained optimization problem model. Finally, at operation 710, post-training quantization is performed based on the assigned bit precision.

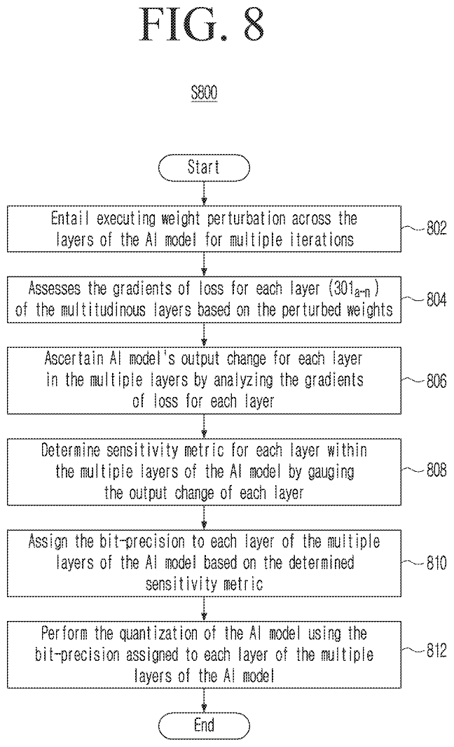

FIG. 8 is a flow chart (S800) illustrating a method for mixed precision quantization of an AI model, according to an embodiment of the disclosure. The operations S802-S812 are handled by the mixed precision quantization controller.

In operation 802, the method entails executing weight perturbation across the layers (301ₐ₋ₙ) of the AI model for multiple iterations. In operation 804, the method involves assessing the gradients of loss for each layer (301ₐ₋ₙ) of the multitudinous layers based on the perturbed weights.

In operation 806 of the method, the AI model's output change for each layer in the multiple layers (301ₐ₋ₙ) is ascertained by analyzing the gradients of loss for each layer. In one embodiment, the output change reflects the loss experienced by each layer within the multiple layers (301ₐ₋ₙ).

Moreover, in operation 808 of the method, the sensitivity metric for each layer within the multiple layers (301ₐ₋ₙ) of the AI model is determined by gauging the output change of each layer. This metric serves as an indicator of the degree of responsiveness of each layer within the multiple layers.

At operation 810, the method includes assigning the bit-precision to each layer of the multiple layers (301ₐ₋ₙ) of the AI model based on the determined sensitivity metric. In an embodiment, the constrained optimization problem model is constructed using the sensitivity metric for each layer of the multiple layers (301ₐ₋ₙ) and a net compression ratio. The bit-precision is assigned to each layer of the multiple layers (301ₐ₋ₙ) of the AI model based on the constrained optimization problem model. In another embodiment, the bit-precision is assigned to each layer of the multiple layers (301ₐ₋ₙ) of the AI model by selecting at least one bit from a bit-precision set based on the sensitivity metric.

At operation 812, the method includes performing the quantization of the AI model using the bit-precision assigned to each layer of the multiple layers of the AI model. In one embodiment, each of the layers (301ₐ₋ₙ) on the assigned bit-precision to obtain an optimal mixed-precision quantized AI model by performing a post training quantization of the AI model using the assigned bit-precision to each of the multiple layers (301ₐ₋ₙ). The optimal AI model obtains the optimal performance of each layer of the multiple layers (301ₐ₋ₙ) of the AI model in terms of at least one of the power level, the amount of memory usage, the level of computational efficiency, and the On-Device learning on the electronic device (101).

This proposed disclosure offers a cost and time effective solution for performing mixed precision quantization of AI models, while maximizing resource utilization. Employing an efficient first-order based mechanism enables optimization of the turn-around time between model development and on-device deployment, without compromising on quality. This approach outpaces other second-order based techniques, providing a swift and effective solution.

By solely leveraging gradient information, the proposed approach yields a reduction in computation requirements and expedites the quantization process, thereby facilitating the execution of quantized models through on-device learning. This method allows for heightened flexibility in running intricate and deeper models at lower bitwidths, creating opportunities to deploy additional models on-device. This, in turn, may lead to a marked improvement in functionality accuracy and performance.

The various actions, acts, blocks, operations, or the like in the flow charts (S700 and S800) may be performed in the order presented, in a different order or simultaneously. Further, in some embodiments, some of the actions, acts, blocks, operations, or the like may be omitted, added, modified, skipped, or the like without departing from the scope of the disclosure.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for mixed precision quantization of an artificial intelligence (AI) model by an electronic device, the method comprising:
performing, by the electronic device, perturbation in weights of each layer of a plurality of layers of the AI model for a pre-defined number of times;
determining, by the electronic device, a change in an output of each layer of the plurality of layers of the AI model based on the perturbation in the weights of each layer of the plurality of layers;
determining, by the electronic device, a sensitivity metric for each layer of the plurality of layers of the AI model as a measure of the change in the output of each layer;
assigning, by the electronic device, a bit-precision to each layer of the plurality of layers of the AI model based on the determined sensitivity metric; and
performing, by the electronic device, the mixed precision quantization of the AI model using the bit-precision assigned to each layer of the plurality of layers of the AI model.

2. The method of claim 1, wherein the determining, by the electronic device, of the change in the output of each layer of the plurality of layers of the AI model comprises:
determining, by the electronic device, gradients of loss of each layer of the plurality of layers based on the perturbing weights of each layer of the plurality of layers; and
determining, by the electronic device, the change in the output of each layer of the plurality of layers of the AI model based on the gradients of loss of each layer of the plurality of layers, wherein the change in the output indicates loss with respect to each layer of the plurality of layers.

3. The method of claim 2, wherein the sensitivity metric for each layer of the plurality of layers of the AI model is determined based on the gradients of loss.

4. The method of claim 1, wherein the assigning, by the electronic device, of the bit-precision to each layer of the plurality of layers of the AI model based on the sensitivity metric comprises:
constructing, by the electronic device, a constrained optimization problem model using the sensitivity metric for each layer of the plurality of layers and a net compression ratio; and
assigning, by the electronic device, the bit precision to each layer of the plurality of layers based on the constrained optimization problem model.

5. The method of claim 1, wherein the performing, by the electronic device, of the mixed precision quantization of the AI model using the bit-precision assigned to each layer of the plurality of layers of the AI model comprises:
enabling, by the electronic device, each layer of the plurality of layers to be on the assigned bit-precision to obtain an optimal mixed-precision quantized AI model by performing a post training quantization of the AI model using the assigned bit-precision to each of the plurality of layers.

6. The method of claim 5, wherein the optimal AI model obtains an optimal performance of each layer of the plurality of layers of the AI model in terms of at least one of a power level, an amount of memory usage, a level of computational efficiency, and On-Device learning on the electronic device.

7. The method of claim 1, wherein the bit-precision is assigned to each layer of the plurality of layers of the AI model by selecting at least one bit from a bit-precision set based on the sensitivity metric.

8. An electronic device for mixed precision quantization of an artificial intelligence (AI) model, the electronic device comprising:
memory;
one or more processors; and
a mixed precision quantization controller, communicatively coupled to the memory and the one or more processors,
wherein the memory store one or more computer programs including computer-executable instructions that, when executed by the one or more processors, cause the electronic device to:
perform perturbation in weights of each layer of a plurality of layers of the AI model for a pre-defined number of times,
determine a change in an output of each layer of the plurality of layers of the AI model based on the perturbation in the weights of each layer of the plurality of layers,
determine a sensitivity metric for each layer of the plurality of layers of the AI model as a measure of the change in the output of each layer,
assign a bit-precision to each layer of the plurality of layers of the AI model based on the determined sensitivity metric, and
perform quantization of the AI model using the bit-precision assigned to each layer of the plurality of layers of the AI model.

9. The electronic device of claim 8, wherein, to determine the change in the output of each layer of the plurality of layers of the AI model, the one or more computer programs further comprise computer-executable instructions to:
determine a gradients of loss of each layer of the plurality of layers based on the perturbing weights of each layer of the plurality of layers, and
determine the change in the output of each layer of the plurality of layers of the AI model based on the gradients of loss of each layer of the plurality of layers, wherein the change in the output indicates loss with respect to each layer of the plurality of layers.

10. The electronic device of claim 9, wherein the sensitivity metric for each layer of the plurality of layers of the AI model is determined based on the gradients of loss.

11. The electronic device of claim 8, wherein, to assign the bit-precision to each layer of the plurality of layers of the AI model based on the sensitivity metric, the one or more computer programs further comprise computer-executable instructions to:
construct a constrained optimization problem model using the sensitivity metric for each layer of the plurality of layers and a net compression ratio, and
assign the bit-precision to each layer of the plurality of layers based on the constrained optimization problem model.

12. The electronic device of claim 8, wherein, to perform quantization of the AI model using the bit-precision assigned to each layer of the plurality of layers of the AI model, the one or more computer programs further comprise computer-executable instructions to:
enable each layer of the plurality of layers to be on the assigned bit-precision to obtain an optimal mixed-precision quantized AI model by performing a post training quantization of the AI model using the assigned bit-precision to each of the plurality of layers.

13. The electronic device of claim 12, wherein the optimal AI model obtains an optimal performance of each layer of the plurality of layers of the AI model in terms of at least one of a power level, an amount of memory usage, a level of computational efficiency, and On-Device learning on the electronic device.

14. The electronic device of claim 8, wherein the bit-precision is assigned to each layer of the plurality of layers of the AI model by selecting at least one bit from a bit-precision set based on the sensitivity metric.

15. The electronic device of claim 8, wherein, to assign the bit-precision to each layer of the plurality of layers of the AI model based on the sensitivity metric, the one or more computer programs further comprise computer-executable instructions to:
decide a final bit configuration for each layer considering total-loss from a loss-estimator and model six constraints.

16. The electronic device of claim 15, wherein the loss-estimator is configured to assign 2 bit, 4 bit, or 8 bit to the AI model.

17. The electronic device of claim 8, wherein the weights of each layer of a plurality of layers is modified by a random noise in a weight tensor.

18. One or more non-transitory computer-readable storage media storing one or more computer programs including computer-executable instructions that, when executed by one or more processors of an electronic device for a mixed precision quantization of an artificial intelligence (AI) model, cause the electronic device to perform operations, the operations comprising:
performing, by the electronic device, perturbation in weights of each layer of a plurality of layers of the AI model for a pre-defined number of times;
determining, by the electronic device, a change in an output of each layer of the plurality of layers of the AI model based on the perturbation in the weights of each layer of the plurality of layers;
determining, by the electronic device, a sensitivity metric for each layer of the plurality of layers of the AI model as a measure of the change in the output of each layer;
assigning, by the electronic device, a bit-precision to each layer of the plurality of layers of the AI model based on the determined sensitivity metric; and
performing, by the electronic device, the mixed precision quantization of the AI model using the bit-precision assigned to each layer of the plurality of layers of the AI model.

19. The one or more non-transitory computer-readable storage media of claim 18, wherein the operations further comprising:
determining, by the electronic device, gradients of loss of each layer of the plurality of layers based on the perturbing weights of each layer of the plurality of layers; and
determining, by the electronic device, the change in the output of each layer of the plurality of layers of the AI model based on the gradients of loss of each layer of the plurality of layers, wherein the change in the output indicates loss with respect to each layer of the plurality of layers,
wherein the sensitivity metric for each layer of the plurality of layers of the AI model is determined based on the gradients of loss.

20. The one or more non-transitory computer-readable storage media of claim 18,
wherein the assigning, by the electronic device, of the bit-precision to each layer of the plurality of layers of the AI model based on the sensitivity metric further comprising:
constructing, by the electronic device, a constrained optimization problem model using the sensitivity metric for each layer of the plurality of layers and a net compression ratio, and
assigning, by the electronic device, the bit precision to each layer of the plurality of layers based on the constrained optimization problem model,
wherein the performing, by the electronic device, of the mixed precision quantization of the AI model using the bit-precision assigned to each layer of the plurality of layers of the AI model further comprising:
enabling, by the electronic device, each layer of the plurality of layers to be on the assigned bit-precision to obtain an optimal mixed-precision quantized AI model by performing a post training quantization of the AI model using the assigned bit-precision to each of the plurality of layers,
wherein the optimal AI model obtains an optimal performance of each layer of the plurality of layers of the AI model in terms of at least one of a power level, an amount of memory usage, a level of computational efficiency, and On-Device learning on the electronic device, and
wherein the bit-precision is assigned to each layer of the plurality of layers of the AI model by selecting at least one bit from a bit-precision set based on the sensitivity metric.
